(19) United States
(12) Patent Application Publication
(10) Pub. No.: US 2026/0203847 A1
(43) Pub. Date: Jul. 16, 2026

(54) SYSTEM AND METHOD FOR WEAPON DETECTION

(71) Applicant: EMTECH SPACE P.C. (CY) LTD., LARNACA (CY)

(72) Inventors: STYLIANOS TSATALAS, LARNACA (CY); NIKOLAOS ANTONIOS LIVANOS, ATHENS (GR); ATHANASIOS KOTSARAS, ATHENS (GR)

(73) Assignee: EMTECH SPACE P.C. (CY) LTD., NICOSIA (CY)

(21) Appl. No.: 19/136,363

(22) PCT Filed: Dec. 11, 2023
(86) PCT No.: PCT/EP2023/085028

§ 371 Date: Jun. 6, 2025

Related U.S. Application Data
(60) Provisional application No. 63/431,896, filed on Dec. 12, 2022.

(51) Int. Cl. G06Q 50/26; G06V 20/40; G06V 20/52; G06V 40/16; G11B 27/34; H04N 5/91

(52) U.S. Cl. CPC G06Q 50/265; G06V 20/41; G06V 20/52; G06V 40/166; G11B 27/34; H04N 5/91

(57) ABSTRACT

A concealed weapons detection system and method are described based on magnetic field measurements. Magnetic field measurements from magnetometers and video feeds from the surrounding area are pre-processed, timestamped and combined into a combined signal. The combined signal is fed to a processor which runs a set of algorithms that produce possible optimized solutions for magnetic dipoles corresponding to weapons and other ferromagnetic objects in the scene. Statistical analysis of the possible solutions is then used to produce a final solution of the most probable weapons in the scene, which are then presented to a human security person as a visual or audiovisual alarm.

### BACKGROUND

### Field The present invention relates to a system and method for weapon detection using magnetic field measurements.

### Background

There is a growing number of public shootings worldwide. Reasons range from political or religious terrorism, to racism and mental illness. Affected locations also have a wide range of variety, from schools to public squares to concert venues. Such incidents'impact on society cannot be stressed enough. Current solutions to contain the problem at different levels include surveillance systems, regulatory actions concerning the sale, possession and use of firearms.

Surveillance methods currently used include Closed-Circuit Tele Vision (CCTV), X-ray scanning of bags, humans, etc. at the entrance of the public spaces, body-searches, metal detectors, etc. Most if not all of these surveillance methods are at best invasive to the public's privacy. Moreover, security screenings commonly employed in places like airports, museums, state buildings etc. create congestion especially at times of high traffic. This is a direct result of their architecture: most of these surveillance methods require people streamlining in order to process each one of them, such as security screening procedures at airports, effectively creating delays, frustration, and significant costs for security staff and complex security equipment. There are cases that this level of invasiveness is inevitable as during airplane boarding different kind of threats are screened and tolerance to false negative results of the screening process is minimal or zero. In contrast, in public spaces, where several of the objects that are prohibited during flights do not pose a threat, different procedures and levels of security are acceptable, resulting in avoiding streamlining and reducing delays, customer or citizen satisfaction, and costs.

Moreover, there are public spaces where airport-type security screening procedures cannot be applied at all as they would severely impact use of the public spaces and associated services and would completely alter their intended use by the public, or even render them unappealing to use by the public. Such an example is a public square, a mall or a metro station. It is very difficult to apply effective screening for carried weapons in these kind of sites without interfering with traffic flow.

As a result, various systems and methods have been developed and deployed at various sites, depending on the required security level and the acceptable disruption of regular use of the said sites. Among the technologies and methods tested and deployed are video-surveillance, and magnetic scanning. The former is particularly effective for detecting persons and their identities (e.g. wanted persons), and suspicious behaviors but fails to detect weapons as these are almost always concealed under clothes on in briefcases, etc. The latter is effective in detecting ferromagnetic objects like weapons, but suffers from limitations associated with interference from other ferromagnetic objects commonly carried by humans, such as coins, belts, watches, and other metallic objects.

Various attempts have been made to overcome the inherent limitations and problems of the previous two systems and methods. Among these attempts are the use of complex signal processing algorithms, and the use of Artificial Intelligence (AI) and Machine Learning (ML), as well as, millimeter-wave, InfraRed (IR) and ultrasound imaging for revealing concealed objects, and multi-algorithm analysis of magnetic measurements and comparison with known magnetic signatures of objects classified as security threats (e.g. firearms, knives, etc.).

Nevertheless, and despite the improvements brought by the combination of the above-mentioned systems and techniques, accurate detection of objects classified as security threats is still a long way from optimum when disruption of ordinary human routine is to be avoided. One may consider a weapon detection system installed at a train station or shopping center, e.g, in the form of a gate. People would cross the security gate(s) simply by flocking through them and not one by one with a minimum prescribed distance between them. It is exactly this characteristic of human behavior at times of heavy traffic (e.g. on a workday morning or on a Saturday early afternoon) that creates a lot of interference between humans and the objects they carry that makes security screening systems produce very unreliable results and miss detecting guns and other similar objects that are carried by the humans through the security gates, and fail to associate a detected weapon with the person carrying it, thereby making it more difficult for security staff to intercept this person before he disappears in the crowd.

There is, therefore, a need for a system and method for accurate detection of objects classified as security threats, and which are suitable for use in busy areas while allowing free movement and being not invasive.

### SUMMARY

The present innovative solution solves the problem of increasing the accuracy of ferromagnetic material weapon detection in public spaces without altering normal people routines.

Herein, a concealed weapons detection system is described and relevant methods to detect concealed weapons. The proposed system employs magnetic measurements, video feed from the surrounding area and algorithms related to modelling the measured field with input information extracted from the video feed, evaluating the different modelling results, picking the best fitting one based on predetermined criteria in order to decide whether there is a person or persons carrying concealed weapons within a certain area monitored by the system.

The concept relies on the property of ferromagnetic materials to exhibit remanent and induced magnetic fields. Depending on their exact volume, mass and specific material the field may exhibit different properties. This field can be measured by a suitable system and the position and possibly other properties of the material can be deduced. In the system described here, the video feed that captures the surroundings is processed and information regarding the position in 3D space of persons and objects present in the scene is extracted. At the same time, magnetic measurements are performed and stored (through vector magnetometers and corresponding data acquisition devices (DAQs)). Both the video feed and the measurements are synchronized. This information is passed to the modelling algorithm which uses it to initiate the search for solutions with positions in the search space confined within the corpi of the present persons. The modelling algorithm is run in multiple parallel instances with different initial conditions. This parallel execution is performed locally, either on a single system or distributed across local systems (EDGE paradigm).

In an alternative exemplary implementation, when the local resources are not sufficient, the parallel execution is performed on the cloud. The process is orchestrated by an appropriate framework that can scale the operation as needed (multiple instances of the same initial conditions or instances with different initial conditions). The eventual solutions from the parallel optimizations are gathered and evaluated. A criterion used is purely statistical: the solution(s) that appear more frequently in the results (or at least approximately the solutions) are chosen as the solution that best represent the optimal one. The algorithm that makes the choice is named the evaluation algorithm. If some prerequisites are met, the solution may match a “detection”, i.e. the possible presence of a concealed weapon on some individual from the scene. The system then notifies the end user via a corresponding app about the threat and the person related to the threat in the video feed.

### BRIEF DESCRIPTION OF THE DRAWINGS

FIG. 1A shows a simplified exemplary view of a security gate according to the present innovative solution.

FIG. 1B shows a simplified exemplary view of security posts according to the present innovative solution.

FIG. 2 shows an exemplary high-level system architecture of the present innovative solution for a weapon detector.

FIG. 3 shows an exemplary medium-level system architecture of the gates and posts of the present innovative solution for a weapon detector.

FIG. 4 shows an innovative methodology for detecting weapons.

FIG. 5 shows how the final solution is selected from all the possible solutions

### DETAILED DESCRIPTION

Any embodiment described herein as “exemplary” is not necessarily to be construed as preferred or advantageous over other embodiments.

The term “exemplary” is used herein to mean “serving as an example, instance, or illustration”.

The acronym “ASIC” is intended to mean “Application-Specific Integrated Circuit”.

The acronym “CCTV” is intended to mean “Closed-Circuit Tele Vision”.

The acronym “CD” is intended to mean “Compact Disc”.

The acronym “DSL” is intended to mean “Digital Subscriber Line”.

The acronym “DVD” is intended to mean “Digital Versatile Disc”.

The acronym “S/W” is intended to mean “Software”.

The acronym “XML” is intended to mean “extensible Markup Language”.

The term “mobile device” may be used interchangeably with “client device” and “portable device with wireless capabilities”.

The term “video stream” may be used interchangeably with “video feed”, “video” and “video signal” unless otherwise explicitly stated or implicitly hinted at in the description, or obvious to a reader of ordinary skill in related art that these terms refer to different things, as this is apparent by the context of the discussion in which they appear.

The term “magnetic sensor” may be used interchangeably with “magnetometer” unless otherwise explicitly stated or implicitly hinted at in the description, or obvious to a reader of ordinary skill in related art that these terms refer to different things, as this is apparent by the context of the discussion in which they appear.

The term “user” may be used interchangeably with “regular user”, “ordinary user”, “customer” and “client”. It may also be used to mean “user of an application” or “user of a service”. It may also be used to refer to a “patient using a device, application, or service”, or to a “client using a device, application, or service”, unless otherwise explicitly stated or implicitly hinted at in the description, or obvious to a reader of ordinary skill in related art that these terms refer to different things, as this is apparent by the context of the discussion in which they appear.

The term “human” may be used interchangeably with “pedestrian”, “person crossing an area in the vicinity of one or more magnetometers” and the like.

The term “system” may be used interchangeably with “device”, “computing device”, “apparatus”, “computing apparatus”, “security screening device”, “security screening apparatus”, “weapon detection device”, “weapon detection apparatus”, and “service”, except where it is obvious to a reader of ordinary skill in related art that these terms refer to different things, as this is apparent by the context of the discussion in which they appear. Under any circumstance, and unless otherwise explicitly stated or implicitly hinted at in the description, these terms should be considered to have the broadest meaning, i.e. that of encompassing all six.

The term “module” may be used interchangeably with “sub-module”, “unit” or “subunit”, except where it is obvious to a reader of ordinary skill in related art that these terms refer to different things, as this is apparent by the context of the discussion in which they appear.

The term “magnetometer” may be used interchangeably with “magnetic field detector”, “magnetic sensor”, and “magnetic field sensor”, except where it is obvious to a reader of ordinary skill in related art that these terms refer to different things, as this is apparent by the context of the discussion in which they appear.

### An Exemplary Weapon Detection System According to the Present Innovative Solution

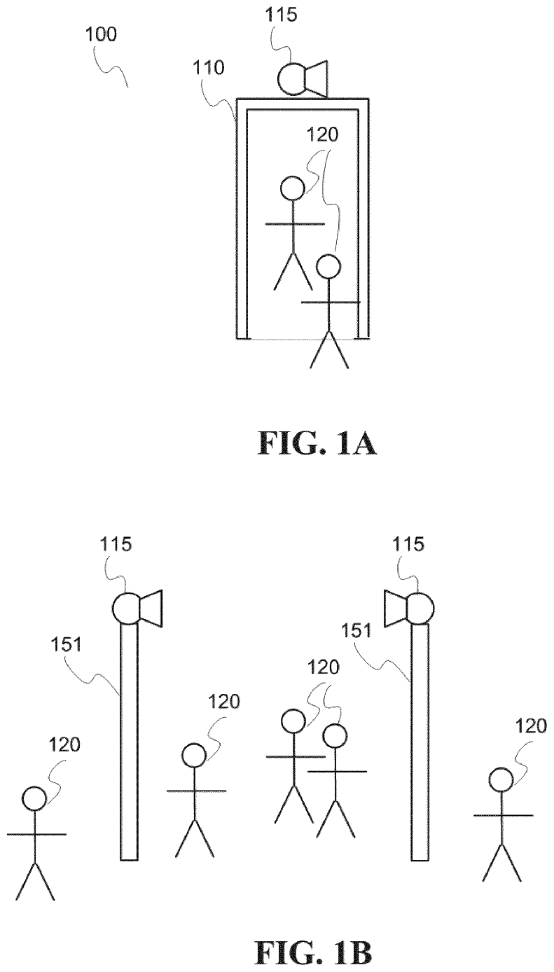

FIG. 1A shows a simplified exemplary view of a security gate according to the present innovative solution. Security screening installation 100 has a security gate 110 similar to the security gates—metal detectors used at airport security checkpoints. Security gate 110 optionally has a camera 115 installed at any position on the gate 110. In another aspect, camera 115 is installed at any location proximal to gate 110. Camera 115 is set to record video from the area of gate 110, allowing to survey all humans 120 crossing gate 110. In another aspect, additional cameras 115 are used for capturing different views of humans 120. In yet another aspect, additional security gates 110 (not shown) are installed adjacent to gate 110 for covering a large area crossed by humans 120. Gates 110 are intended to capture magnetic disruptions from 360° around them and using appropriate signal processing to focus on magnetic disruptions in the opening of each gate 110 and optionally a virtual corridor through gate 110. Each gate 110 contains one or more 3D magnetic sensor-magnetometer (not shown) which is intended to capture/measure magnetic field strength in all three directions (z, y, z) at any time.

FIG. 1B shows a simplified exemplary view of security posts according to the present innovative solution. Security screening installation 150 has a security post 151. Security post 150 optionally has a camera 115 installed at any position on post 150. In another aspect, camera 115 is installed at any location proximal to post 150. Camera 115 is set to record video from the area around post 150, allowing to survey all humans 120 crossing the area around post 150. In another aspect, additional cameras 115 are used for capturing different views of humans 120. In yet another aspect, additional posts 152 are installed adjacent to post 151 for covering a large area crossed by humans 120. Posts 152 may, in one aspect be installed serially to cover a wide opening, or in a grid configuration to cover a large area crossed by humans 120 and/or to correct detection from other posts and/or gates. Each post 151, 152 contains one or more magnetic sensors (not shown) which is intended to capture magnetic field strength from 360° around it, along the x, y, z axes.

In another, aspect the magnetic sensors (or magnetometers) capture (or measure) magnetic field strength in any of the x, y, z directions, so combination of three different sensor measurements are used to measure the magnetic field strength along the x, y, z axes.

In yet another exemplary implementation a mixture of gates 110 and posts 151, 152 may be used to cover large and/or complex areas crossed by humans 120.

Both gates 110 and posts 151, 152 are mechanical structures made of non-metallic or non-ferromagnetic materials for not interfering or masking the magnetic field disruptions that gates 110 and posts 151, 152 are designed to detect. Their detailed shape is not limiting the scope of the present innovative solution. In one exemplary implementation the vertical and horizontal members of gates 110 and of posts 151, 152 are cylindrical (any other shape may be used instead), each housing one or more magnetometers (i.e. magnetic sensors designed to detect perturbations to the standard magnetic field of the Earth, caused by induced electromagnetic fields and/or by the influence of ferromagnetic materials, like weapons, in the vicinity of gates 110 and posts 151, 152). In addition to the magnetometers, gates 110 and posts 151, 152 may also contain other sensors, Light Emitting Diodes (LEDs), and electronics like pre-processors, Analogue-to-Digital Converters (ADC), and processors designed to filter, condition and pre-process the signals from the magnetometers and other optional sensors, and optionally to process the processed magnetometer signals with the video feeds from cameras 115.

In another exemplary embodiment, the processing of the magnetometer and camera signals is done at one or more processors outside of gates 110 and posts 151, 152). In yet another exemplary embodiment, the processing is done at a distributed or at a cloud infrastructure. Various combinations of processing infrastructures can be used without departing from the scope of the present innovative solution.

In the exemplary embodiments, the same type or a combination of different types of magnetic sensers may be used, such as a 3D magnetometer, combinations of 1D magnetometers or other.

### System Architecture

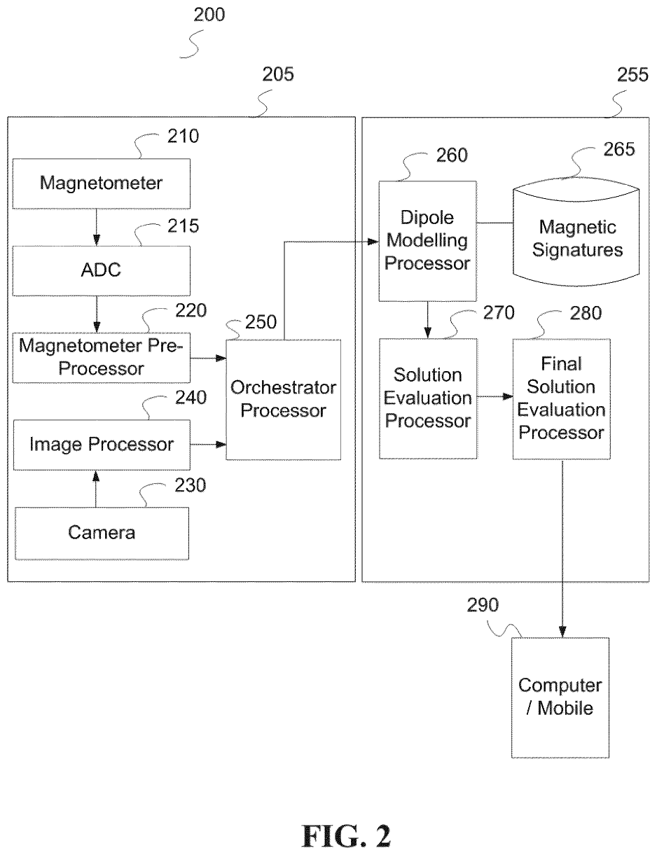

FIG. 2 shows an exemplary high-level system architecture of the present innovative solution for a weapon detector. Weapon detection system 200 has a first module 205, which is implemented by one or more gates 110 and posts 151, 152, and a second module 255, which in one exemplary embodiment forms part of gates 110 and posts 151, 152 while in another exemplary embodiment is a separate processing module, or a distributed processing module, or a cloud infrastructure.

First module 205 has one or more magnetometer 210, each connected to an Analogue to Digital Converter (ADC) 215 for digitizing the analogue signals produced by magnetometers 210. The digitized magnetometer signals are then fed to one or more magnetometer pre-processor 220, which filters, conditions and pre-processes the digitized signals, e.g. removing the earth's standard magnetic field and other known biases as to enable the detection of small magnetic perturbations caused by ferromagnetic materials, such as weapons, in the vicinity of the magnetometer.

In another exemplary implementation the filtering and conditioning of the magnetometer signals is performed on the analogue magnetometer signals, prior to their digitization, or to both the analogue and the digitized magnetometer signals.

One or more camera 230 is installed onto or proximal to gates 110 and posts 151, 152 which feeds one or more digital video stream from a surveillance area to one or more image processor 240, which is set to process the video stream. In one aspect, image processor 240 performs pre-processing to the video feed, while in another aspect it performs full-scale image processing using one or more image analysis, computer vision, and image understanding algorithms. For example, image processor 240 performs face detection, while in another aspect it also performs human body detection, object detection, etc. If more than one camera is used, then more than one video feed is sent to image processor 240 which outputs a corresponding number of outputs to the next module it connects to.

The digitized and preprocessed magnetometer signals and the camera feed are fed to an orchestrator processor 250, which is designed to timestamp and combine the signals from more than one magnetometer and cameras, and from more than one gate 110 and post 151, 152, e.g. for increasing the contextual information to be analyzed by the system with the aim to increase the accuracy of detection of concealed weapons carried by humans crossing areas where gates 110 and posts 151, 152 are installed.

The output of orchestrator processor 250 is fed to second module 255, which in one exemplary embodiment is a distributed processing infrastructure, or a cloud infrastructure. In another exemplary implementation, second module 255 is part of first module 205, or is split between first module 205 and one or more of a distributed processing infrastructure and a cloud infrastructure.

Second module 255 has a magnetic dipole modeling processor 260, a solution evaluation processor 270, and a final solution evaluation processor 280. Magnetic dipole modeling processor 260 receives the signals from the orchestrator processor 250, which contains processed (or pre-processed) signals from magnetometers 210 and cameras 230, and processes them according to one or more modelling algorithm that identifies magnetic dipoles in the signals received from magnetometers 210. By combining readings from more than one magnetometer 210, magnetic dipole modeling processor 260 analyzes perturbation in the 3 dimensions (x, y, z) of the earth's magnetic field caused by ferromagnetic materials proximal to the magnetometers. Since these perturbations are caused by any ferromagnetic material, not necessarily a weapon, it is very difficult to distinguish between the materials that cause these perturbations. To improve the accuracy of weapon detection, the modelling algorithms implemented by magnetic dipole modeling processor 260 optionally exploits knowledge of magnetic signatures of one or more known weapon type and other objects stored in a magnetic signature database 255. This is a feature also used in prior art.

However, as many ferromagnetic objects and humans carrying these objects may be at close proximity to each other, it is still very difficult to differentiate magnetic dipoles from weapons over other objects and understand who is carrying these weapons. This detection is further complicated by the fact that the human carrying the ferromagnetic objects are moving, potentially at a fast pace and occasionally even touch each other or cross their paths. For this reason, our innovative solution exploits the processed camera feed produced by image processor 240. In this processed video feed, the faces and optionally the silhouettes of humans and their carry bags and other objects are tracked. This information, which is produced by image processor 240, is combined by orchestrator processor 250 with the pre-processed magnetic readings produced by magnetic pre-processor 220, and is analyzed by dipole modelling processor 260, using magnetic signatures from database 265. As a result, dipole modelling processor 260 uses the processed video of humans (and optionally their bags and other objects they carry) in the vicinity of gates 110 and posts 151, 152 to guide its modelling algorithms to assign magnetic perturbations to magnetic dipoles, or in other exemplary implementation to magnetic dipoles and quadrupoles, etc. For example, two magnetic dipoles at close vicinity to each other may or may not be a weapon. Using the analyzed video feed to create a scene map of the humans and objects in the detection area, dipole modelling processor 260 projects (or distributes) the magnetic dipoles to the detected human silhouettes and/or or on other objects carried by humans and/or even on other recognized objects in the scene, and thus creates a dipole map that differentiates between potential dipole positions that may correspond to the human silhouettes or bags in the scene map. If some dipoles do not project onto the humans or bags in the scene map, then these dipoles do not belong to perturbations that are due to weapons (but could be interference and noise and are thus rejected) as weapons are expected to be carried by humans either attached to their bodies, or inside bags etc. placeholders. In one aspect more than one dipole maps are created by dipole modelling processor 260 as a result of the ambiguity or uncertainty that may be involved in the creation of the dipole maps.

Magnetic dipole maps (i.e. sets of magnetic dipoles) are fed from dipole modelling processor 260 to solution evaluation processor 270, which runs in parallel a number of algorithms for evaluating the at least one set of solutions produced by the dipole modelling processor, which algorithms produce a number of solutions. Each of these solutions contains a possible identification of ferromagnetic objects and signals, those that are deemed potential weapons by solution evaluation processor 270.

Furthermore, if the set of dipoles does not correspond on dipoles on the human silhouettes, the carried objects or the other recognized objects in the scene, these solutions receive a lower rating/are not preferred.

The possible solutions produced by solution evaluation processor 270 are fed to final solution evaluation processor 280, which selects a final solution containing the most probable identification of potential concealed weapons. It is noted that the present system and method can also identify unconcealed weapons carried by humans in the vicinity of gates 110 and posts 151, 152. The evaluation and selection are made using a confidence score, or probability score, or other metric known from the prior art.

In one aspect, the evaluation method run by solution evaluation processor 270 also provides feedback to the next modelling processes run by final solution evaluation processor 280, and examines the continuity of the set of dipoles in the time domain. For example, a solution or set of solutions might be discarded if, on a previous time stamp or multiple time stamps, the set of dipoles representing the field have been displaced abnormally (e.g. not-following a progressive pattern) in the search area or seem to appear suddenly or disappear suddenly (e.g. not by progressively moving out of the scene). In the modelling processes about to ensue on the next timestamps, the initialization may favor solutions that adhere to time-continuity in that sense (e.g. progressive movement across time as it is represented by timestamps).

The final solution is then used by final solution evaluation processor 280 to create an audio, visual, or audio-visual alarm signal to alert security staff to the threat posed by the person carrying the identified weapons. This alarm is produced only if a potential weapon has been detected and may be effected by a speaker and/or a light source onto or proximal to gates 110 and posts 151, 152. Additionally, or alternatively, an alarm is communicated to a computer or to a mobile device 290 used by security staff, and/or to a central security surveillance and management system, like the ones used by security companies, police forces and the like.

In one aspect, the time-continuous set of solutions that are selected and evaluated will in the end provide a set of “targets” of magnetic origin that move around in the scene and are thus tracked. Additionally, or alternatively to the detection event and alarm, a visualization of the targets moving around in the scene may be the output to be transmitted to the end user via an appropriate Graphical User Interface (GUI).

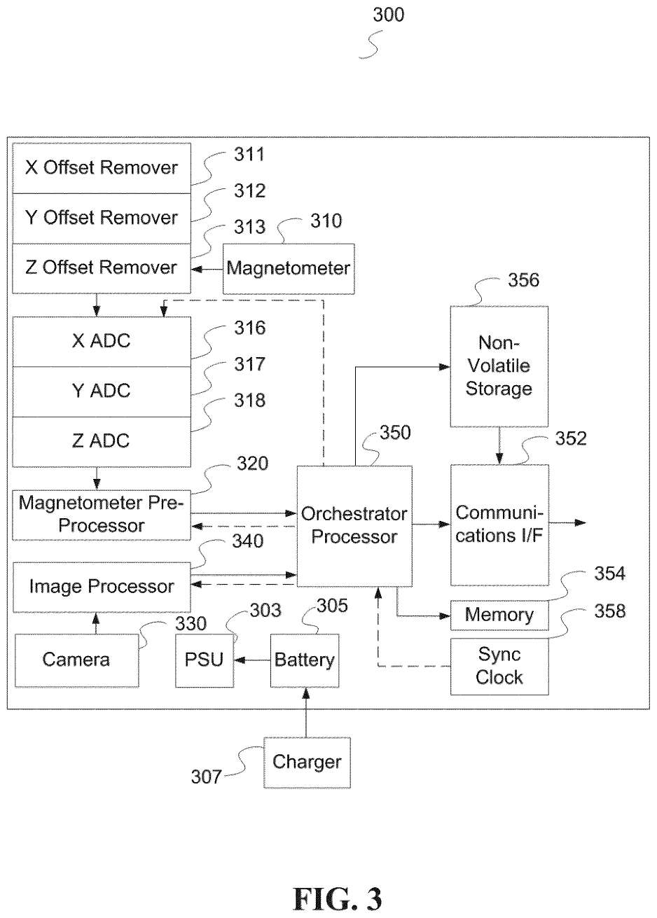

FIG. 3 shows an exemplary medium-level system architecture of the gates and posts of the present innovative solution for a weapon detector. System architecture 300 has one or more magnetometers 310, each connected to an X-axis offset remover module 311, a Y-axis offset remover module 312, and a Z-axis offset remover module 313, for offsetting the earth's standard magnetic field and the fields from known nearby sources so as to produce magnetic readings that contain very small magnetic signals (compared to the earth's magnetic field), which can thus be detected with higher accuracy. The offset signals for each of the three directions, which are produced by offset removers 311, 312, 313, are each fed to a corresponding ADC 316, 317, 318 for digitization. The digitized magnetometer signals are then fed to magnetometer pre-processor 320, which filters, conditions and pre-processes the digitized signals.

At the same time, one or more cameras 330 (which are connected to a Power Supply Unit (PSU) 303, fed by a battery 305, which is charged by charger 307) capture live video which is processed by image processor 340. The same PSU 303 feeds the magnetometers and other processors of system architecture 300.

The processed magnetometer signals and the processed camera feeds are fed to orchestrator processor 350, which communicates with module 255 and with external systems with communications interface 352 (i.e. a standard wireless and wired communications interface supporting any known communications standards). Orchestrator processor 350 is also connected to a memory 354, non-volatile storage 356, and a synchronization clock 358. The clock signal is shared by all modules of architecture 300, while memory 354 and non-volatile storage 356 may also be share if no other memory and non-volatile storage modules are used by other processors of architecture 300.

### Methodology for Detecting Weapons

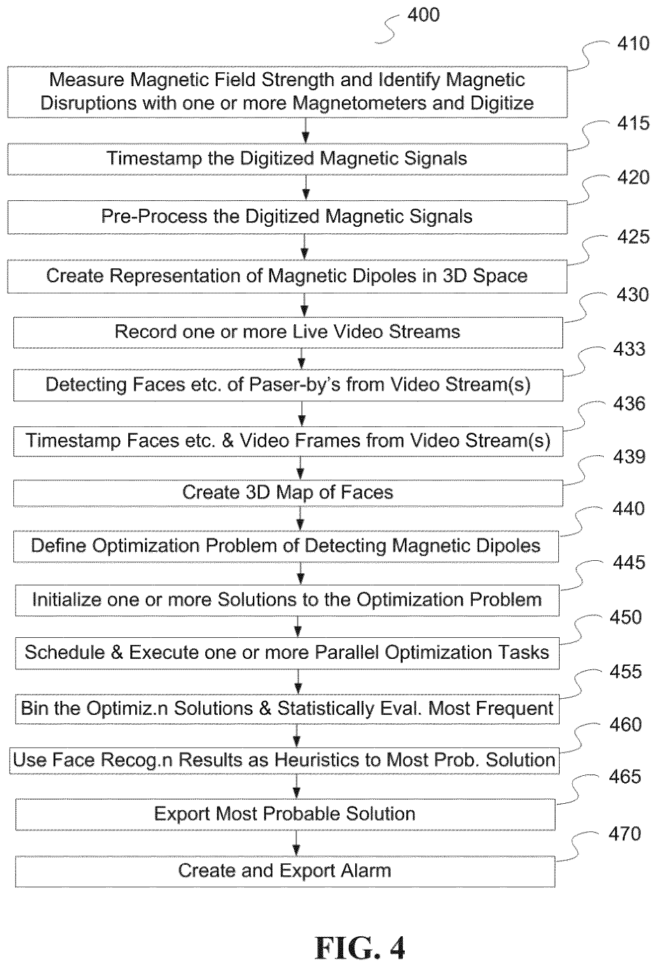

The novel innovative solution for detecting weapons, as previously presented in the system architecture section, is used to implement an innovative methodology for detecting weapons. FIG. 4 shows an innovative methodology for detecting weapons. In a first exemplary implementation, methodology 400 starts by measuring ambient magnetic field strength 410, identifying magnetic disruptions with one or more magnetometers 210 and producing one or more analogue magnetic signals, digitizing the analogue magnetic signals with ADC 215, timestamping 415 and pre-processing 420 the digitized magnetic signals with the magnetometer pre-processor 220. Pre-processing may contain offsetting, filtering, conditioning etc. using any algorithm known from prior art.

At the same time as step 410 is executed, one or more cameras record live video streams 430, which contain humans (i.e. passerby's) crossing the area proximal to the magnetic sensors. Any known image processing algorithm is implemented by image processor 240 to analyze the video streams for detecting human faces 433, and optionally human bodies, and objects handed by these humans.

Orchestrator processor 250 collects, timestamps and combines the processed digitized magnetic measurements of step 420 from the one or more magnetometers and the analyzed video feeds of step 433 from the one or more cameras for increasing the contextual information to be analyzed by the system with the aim to increase the accuracy of detection of concealed weapons carried by humans crossing areas where gates 110 and posts 151, 152 are installed.

Dipole modeling processor 260 defines an optimization problem for detecting magnetic dipoles 440 using the outputs of step 433. It processes the timestamped signals from the orchestrator processor with at least one initial solution allocator/initializer and initializes solutions for identifying magnetic dipoles 445, using magnetic signatures of at least one known weapon type and at least one other object made of ferromagnetic material, in the surveillance area.

Magnetic dipoles are the solutions that correspond to a set of models that fully account for the measured field. At this point only the magnetic measurements themselves are passed to the next step, digitized and optionally pre-processed (e.g. digitally filtered). Magnetic dipoles as a representation of the field only enter the process as the initialized solutions and the final solutions.

In another aspect, the initialization of the solutions is done by orchestrator processor 250.

In one aspect, dipole modeling processor 260 creates a scene map (containing humans, their bags, etc.) and then projects magnetic dipoles onto the detected human silhouettes and their bags in the scene map, and thus optionally creates a dipole map that differentiates between potential dipole positions that may belong to the human silhouettes and bags in the scene map. If some dipoles do not project onto the humans and bags in the scene map, then these dipoles do not belong to perturbations that are due to weapons (but could be interference and noise) as weapons are expected to be carries by humans either attached to their bodies, or inside bags etc. placeholders. In one aspect more than one dipole maps are created by dipole modelling processor 260 as a result of the ambiguity or uncertainty that may be involved in the creation of the dipole maps Solution evaluation processor 570 initializes one or more solutions of the optimization problem 445 using the pre-processed magnetic field measurements of step 420, and schedules and executes one or more parallel optimization tasks 450. The different initial conditions used by solution evaluation processor 570 are, for example, different dipole maps, different weighs (e.g. probability weights) on the dipoles of the dipole maps, etc.

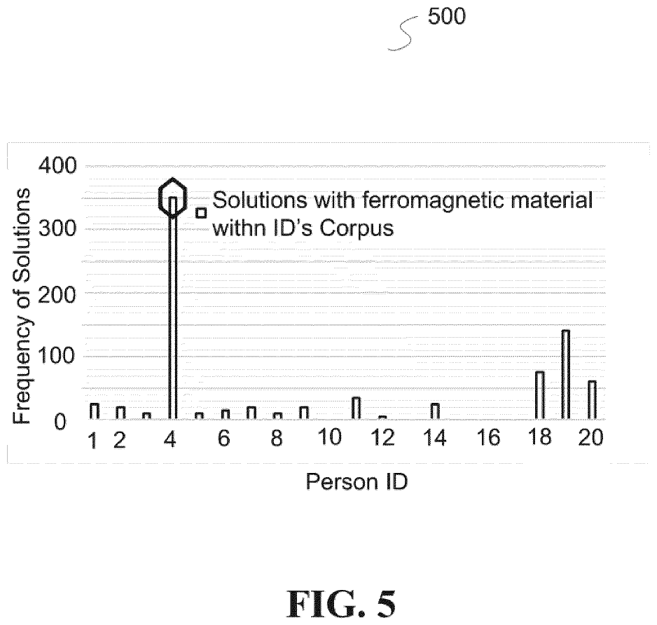

Final solution evaluation processor 280 takes as input the optimization solutions of step 450, bins and statistically evaluates the most frequent of these solutions 455, and uses the detected human faces, and optionally human bodies, and objects handed by these humans, produced in step 433, together with the magnetic signatures of known weapons (and optionally of other known common ferromagnetic materials) from database 265 as heuristics for selecting the most probable solution, i.e. the likely most accurate estimate of one or more weapons carried by one or more persons in the vicinity of the magnetometers. The solution with the highest frequency of occurrence is selected (as shown in FIG. 5).

Having selected the optimal solution, 290 to the optimization problem, final solution evaluation processor 280 exports the most probable solution 465 (which is produced using time-continuity evaluation, and optionally creates an alarm 470 if a weapon has been detected. The alarm and/or the most probable solution are communicated by final solution evaluation processor 280 (or by an optional separate communications module) to one or more speaker and/or a light source on or proximal to gates 110 and posts 151, 152, and to a computer or to a mobile device 290 used by security staff, and/or to a central security surveillance and management system, like the ones used by security companies, police forces and the like. By means of example, the alarm may be an audio, visual, or audio-visual alarm to alert security staff to the threat posed by the person(s) carrying the identified weapons.

The use of heuristics data derived from the analysis of video data and the magnetic field measurements can improve the accuracy of the estimated solution to the optimization problem as methodology 400 uses additional data having a richer information context compared to the prior art.

This innovation is contrary to the systems and methods in the prior art, where video feeds are used only for detecting human presence in a detection area, or for visualization purposes where specific humans or their bags are highlighted for facilitating invigilators (i.e. security staff) to see where the system believes weapons are hidden. The prior art does not use video feeds to guide the detection algorithms to more accurately detect magnetic dipoles carries by humans.

In a second exemplary implementation of methodology 400, the magnetic field measurements are also timestamped 415 by magnetometer pre-processor 220, and the extracted faces (and optionally bodies and objects carried by persons in the vicinity of the magnetometers) are timestamped 436 by image processor 240, and are used in steps 445, and 460. The use of timestamped (i.e. time series) data for the magnetic field measurements and the detected faces etc. can improve the accuracy of the estimated solution to the optimization problem as methodology 400 uses additional data having a richer information context compared to the first exemplary implementation of methodology 400 and the prior art.

The second exemplary implementation of methodology 400 contains all the steps of the first exemplary implementation of methodology 400.

A third exemplary implementation of methodology 400 also includes, over the second exemplary implementation of methodology 400, creating a representation of magnetic dipoles allocated in 3D space that account for the measured field on the magnetometer in step 425, and a 3D map of extracted faces of (and optionally bodies and objects carried by) humans in the vicinity of the magnetometers 439, Step 445 initializes one or more solutions of the optimization problem for each timestamped magnetic field measurement from the one or more magnetometers.

Step 460 uses the timestamped 3D map of the extracted faces of (and optionally bodies and objects carried by) humans in the vicinity of the magnetometers as heuristics. The use of timestamped (i.e. time series) 3D data for the magnetic field measurements and the detected faces etc. can improve the accuracy of the estimated solution to the optimization problem as methodology 400 uses additional data having a richer information context compared to the first and the second exemplary implementation of methodology 400 and the prior art.

The third exemplary implementation of methodology 400 contains all the steps of the second exemplary implementation of methodology 400.

FIG. 5 shows how the final solution is selected from all the possible solutions. Graph 500 depicts a total of (e.g.) 20 possible solutions (x-axis) for a Person ID (i.e. a person captured by the one or more video cameras of the system and identified by the system's processors. These 20 solutions are produced by the one or more algorithms used by the system using different initial conditions. The y-axis depicts the frequency of occurrence of these 20 solutions in the total set of solutions (i.e. more than 20 solutions in the total set of solutions) produced by the one or more algorithms. Out of these 20 solutions, the fourth solution is the one with the highest frequency (i.e. 360 times). Solutions 18-20 have a frequency above 50, and the rest of the solutions have a frequency of below 50. As a result, the system selects the fourth solution as the most probable solution and outputs it. This way, the sheer number of occurrences of a possible solution, created using different initial conditions and guided by some or all of the face, body, and object recognition applied to the video signals, significantly increase the accuracy of detected concealed weapons.

It is noted that these 20 possible solutions are produced by analyzing video frames (consecutive or non-consecutive, regularly or randomly selected in the video stream), tracking their content (e.g. faces, bodies, objects) in time as they move in space. The solutions are produced by comparing partial solutions corresponding to one moment in time (e.g. by timestamping them) and correlating them to the motion of the faces, bodies, and objects.

The 20 possible solutions are presented only by means of example. More or less possible solutions may be used.

The above exemplary embodiments are presented for use in security doors and security posts. However, they may also be used in any other format and security product using magnetometers without departing from the scope of protection of the invention.

The above exemplary embodiment descriptions are simplified and do not include hardware and software elements that are used in the embodiments but are not part of the current invention, or are not needed for the understanding of the embodiments, or are obvious to any user of ordinary skill in related art. Furthermore, variations of the described system architecture are possible, where, for instance, some servers may be omitted or others added.

The figures and the electro-mechanical and electronic components they illustrate are not necessarily in scale, and their relative positions and interconnections are exemplary. Their variations, which are obvious to persons of skill in related art, are within the scope of protection of the present innovative solution.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at the time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions, pre-processors, processors, and method steps described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage medium may be any available medium that can be accessed by a computer or computing apparatus. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1.-8. (canceled)

9. A system for detecting weapons inside a surveillance area, the system comprising:
at least one security post comprising at least one magnetometer configured to capture magnetic disruptions along at least one of an x, y, z axis in the surveillance area and produce an analogue signal;
at least one Analogue-to-Digital Converter (ADC), each connected to the at least one magnetometer and configured for digitizing the analogue signal produced by each of the at least one magnetometer;
at least one magnetometer pre-processor connected to the at least one ADC and configured for filtering, conditioning and pre-processing digitized signals produced by the at least one ADC;
at least one video camera each configured to capture a video stream from the surveillance area;
at least one image processor connected to the at least one video camera and configured for processing the video streams from the at least one camera;
an orchestrator processor connected to the at least one magnetometer pre-processor and the at least one image processor and configured for timestamping and combining the pre-processed digitized signals from the at least one magnetometer pre-processor and the processed video streams from the at least one image processor;
a dipole modelling processor connected to the orchestrator processor and configured for processing the timestamped signals from the orchestrator processor with at least one modelling algorithm, and outputting at least one set of solutions;
a solution evaluation processor connected to the dipole modelling processor and configured for running in parallel a plurality of algorithms for evaluating the at least one set of solutions, each containing a possible identification of ferromagnetic objects and signals that are deemed potential weapons; and
a final solution evaluation processor connected to the solution evaluation processor and configured for using a metric for selecting a final solution containing a most probable identification of potential concealed weapons, and for creating an alarm signal if a potential weapon has been detected.

10. The system of claim 9, wherein the dipole modelling processor is configured so that each of the at least one modelling algorithm is run with at least one initial condition for producing at least one possible solution by comparing partial solutions corresponding to one moment in time by timestamping the at least one partial solution and correlating the at least one partial solution to motion of faces, bodies, and objects in the processed and synchronized video streams for identifying magnetic dipoles in the surveillance area using an output of the image processor.

11. The system of claim 10, wherein the dipole modelling processor is configured so that the magnetic dipoles in the surveillance area are identified using an output of the image processor by (a) using the processed video stream for creating a scene map of humans and objects in the surveillance area, (b) creating a dipole map by projecting the at least one magnetic dipole to at least one human silhouette and objects in the scene map, wherein the dipole map differentiates between potential dipole positions that correspond to one of humans and other objects in the scene map, and (c) rejecting any of the at least one magnetic dipole that does not project onto one of humans and other objects in the scene map,

12. The system of claim 11, wherein the solution evaluation processor is configured for running in parallel a plurality of algorithms for evaluating the at least one set of solutions by discarding at least one solution if on at least a previous time stamp a set of dipoles representing a field have been displaced abnormally by not-following a progressive pattern in the surveillance area or seem to appear suddenly or disappear suddenly by not progressively moving out of the surveillance area, and by favoring at least another solution if on at least a previous time stamp the set of dipoles representing a field have been displaced normally by following a progressive pattern in the surveillance area.

13. The system of claim 12, further comprising a magnetic signatures database connected to the dipole modelling processor and configured for storing magnetic signatures of at least one known weapon type and at least one other object made of ferromagnetic material, wherein the dipole modelling processor is further configured for using the magnetic signatures of the at least one known weapon type and the at least one other object made of ferromagnetic material for processing the timestamped signals from the orchestrator processor.

14. The system of claim 12, wherein at least one of the at least one video camera is installed at one of the at least one security post.

15. The system of claim 12, wherein at least one of the at least one security post is a security gate.

16. The system of claim 9, further comprising a magnetic signatures database connected to the dipole modelling processor and configured for storing magnetic signatures of at least one known weapon type and at least one other object made of ferromagnetic material, wherein the dipole modelling processor is further configured for using the magnetic signatures of the at least one known weapon type and the at least one other object made of ferromagnetic material for processing the timestamped signals from the orchestrator processor.

17. The system of claim 9, wherein at least one of the at least one video camera is installed at one of the at least one security post.

18. The system of claim 9, wherein at least one of the at least one security post is a security gate.

19. A method for detecting weapons inside a surveillance area, the method comprising:
measuring an ambient magnetic field strength, identifying magnetic disruptions with at least one magnetometer, and producing at least one analogue magnetic signal;
digitizing the at least one analogue magnetic signal with an ADC;
pre-processing the at least one digitized magnetic signal with the magnetometer pre-processor to produce pre-processed magnetic signals;
recording at least one live video stream of the surveillance area with at least one video camera;
processing the at least one live video stream for detecting human faces, bodies and objects with at least one image processor;
timestamping and combining the at least one pre-processed magnetic signal and the at least one processed video stream with an orchestrator processor;
defining with a magnetic dipole modelling processor an optimization problem for identifying magnetic dipoles, and outputting at least one set of solutions, using a solution evaluation processor connected to the dipole modelling processor for running in parallel a plurality of algorithms for evaluating the at least one set of solutions, each containing a possible identification of ferromagnetic objects and signals that are deemed potential weapons; and
binning and statistically evaluating the at least one solution of the optimization problem, and selecting and exporting an optimal solution that has the highest frequency of occurrence using a final solution evaluation processor.

20. The method of claim 19, wherein the magnetic dipole modelling processor defines the optimization problem by processing the at least one timestamped signal from the orchestrator processor with at least one modelling algorithm, each of the at least one modelling algorithm being run with at least one initial condition for producing at least one possible solution by comparing partial solutions corresponding to one moment in time by timestamping the at least one partial solution and correlating the at least one partial solution to motion of faces, bodies, and objects in the processed and synchronized video streams for identifying magnetic dipoles in the surveillance area using an output of the image processor by (i) using the processed video stream for creating a scene map of humans and objects in the surveillance area, (ii) creating a dipole map by projecting the at least one magnetic dipole to at least one human silhouette and objects in the scene map, wherein the dipole map differentiates between potential dipole positions that correspond to one of humans and other objects in the scene map, and (iii) rejecting any of the at least one magnetic dipole that does not project onto one of humans and other objects in the scene map.

21. The method of claim 20, wherein the at least one set of solutions is outputted using the solutions evaluation processor by discarding at least one solution if on at least a previous time stamp a set of dipoles representing a field have been displaced abnormally by not-following a progressive pattern in the surveillance area or seem to appear suddenly or disappear suddenly by not progressively moving out of the surveillance area, and by favoring at least another solution if on at least a previous time stamp the set of dipoles representing a field have been displaced normally by following a progressive pattern in the surveillance area.

22. The method of claim 21, further comprising using, at the magnetic dipole modelling processor, magnetic signatures of at least one known weapon type and at least one other object made of ferromagnetic material for processing the timestamped signals from the orchestrator processor.

23. The method of claim 21, further comprising creating an alarm if a weapon has been detected.

24. The method of claim 19, further comprising using, at the magnetic dipole modelling processor, magnetic signatures of at least one known weapon type and at least one other object made of ferromagnetic material for processing the timestamped signals from the orchestrator processor.

25. The method of claim 19, further comprising creating an alarm if a weapon has been detected.
